(19) United States
(12) Patent Application Publication
(10) Pub. No.: US 2024/0096210 A1
(43) Pub. Date: Mar. 21, 2024

(54) ROADSIDE COMMUNICATION DEVICE, ROADSIDE COMMUNICATION METHOD, AND NON-TRANSITORY COMPUTER READABLE RECORDING MEDIUM

(71) Applicant: NEC Corporation, Minato-ku, Tokyo (JP)

(72) Inventors: Toshiyuki KONDO, Tokyo (JP); Kosei KOBAYASHI, Tokyo (JP)

(73) Assignee: NEC Corporation, Minato-ku, Tokyo (JP)

(21) Appl. No.: 18/274,621

(22) PCT Filed: Mar. 29, 2021
(86) PCT No.: PCT/JP2021/013244

§ 371 Date: Jul. 27, 2023

(51) Int. Cl. G08G 1/01

(52) U.S. Cl. CPC G08G 1/0116; G08G 1/0125

(57) ABSTRACT

To provide a roadside communication device that can transfer, to an appropriate vehicle, information from another vehicle; a roadside communication method; and a recording medium,

this roadside communication device comprises: a reception unit that receives a first wireless signal from a first moving body; a determination unit that determines a notification target range on the basis of at least one among the traffic properties of a road where the first moving body is located, the environmental state of the road, and the attributes of information included in the first wireless signal; and a transmission unit that transmits a second wireless signal including said information to a wireless terminal within the notification target range.

### TECHNICAL FIELD

The present invention relates to a roadside communication device, a roadside communication method, and a recording medium that are capable of transferring information to an appropriate vehicle from another vehicle.

### BACKGROUND ART

In recent years, in order to assist safe driving and achieve automatic driving, techniques relating to vehicle-to-vehicle communication for establishing communication between a vehicle and a vehicle and road-to-vehicle communication for establishing communication between a vehicle and a roadside communication device installed on a road on which a vehicle travels have been developed.

For example, PTL 1 discloses a technique relating to vehicle-to-vehicle communication and road-to-vehicle communication.

### CITATION LIST

### Patent Literature

PTL 1: Japanese Unexamined Patent Application Publication No. 2009-278382

### SUMMARY OF INVENTION

### Technical Problem

In some cases, in road-to-vehicle communication, the roadside communication device receives information from one vehicle, and transfer the received information to another vehicle when the another vehicle is located nearby. In this case, the roadside communication device communicates with a vehicle located within a predetermined range, and transfers the information to the another vehicle.

In this case, an attribute of the information received by the roadside communication device (for example, an importance degree or the like), traffic properties of a road, an environmental state of the road, and the like vary, and hence the roadside communication device is required to transfer the information to an appropriate vehicle according to those factors. However, in the technique described in PTL 1, the range within which the roadside communication device performs transmission is not changed by those factors, and hence the information cannot be transferred to an appropriate vehicle.

The present invention has been made in view of the above-mentioned problem and an object of the present invention is to provide a roadside communication device, a roadside communication method, and a recording medium that are capable of transferring information to an appropriate vehicle from another vehicle.

### Solution to Problem

A roadside communication device according to the present invention includes:
a reception unit that receives a first wireless signal from a first moving body;
a determination unit that determines a notification target range, based on at least one of an attribute of information included in the first wireless signal, traffic properties of a road on which the first moving body is located, and an environmental state of the road; and
a transmission unit that transmits a second wireless signal including the information, to a wireless terminal within the notification target range.

Further, a roadside communication method according to the present invention includes:
receiving a first wireless signal from a first moving body;
determining a notification target range, based on at least one of an attribute of information included in the first wireless signal, traffic properties of a road on which the first moving body is located, and an environmental state of the road; and
transmitting a second wireless signal including the information, to a wireless terminal within the notification target range.

Further, a recording medium according to the present invention records a program causing an information processing device to execute:
processing of receiving a first wireless signal from a first moving body;
processing of determining a notification target range, based on at least one of an attribute of information included in the first wireless signal, traffic properties of a road on which the first moving body is located, and an environmental state of the road; and
processing of transmitting a second wireless signal including the information, to a wireless terminal within the notification target range.

### Advantageous Effects of Invention

According to the present invention, it is possible to provide a roadside communication device, a roadside communication method, and a recording medium that are capable of transferring information to an appropriate vehicle from another vehicle.

### BRIEF DESCRIPTION OF DRAWINGS

FIG. 1 is a block diagram illustrating a configuration example of a roadside communication system according to a first example embodiment of the present invention.

FIG. 2 is a sequence diagram illustrating an operation example of the roadside communication system according to the first example embodiment of the present invention.

FIG. 3 is a diagram for describing a configuration example of a roadside communication system according to a second example embodiment of the present invention.

FIG. 4 is a sequence diagram illustrating an operation example of the roadside communication system according to the second example embodiment of the present invention.

FIG. 5 is a diagram for describing a configuration example of a roadside communication device according to a third example embodiment of the present invention.

FIG. 6 is a flowchart illustrating an operation example of the roadside communication device according to the third example embodiment of the present invention.

### EXAMPLE EMBODIMENT

### First Example Embodiment

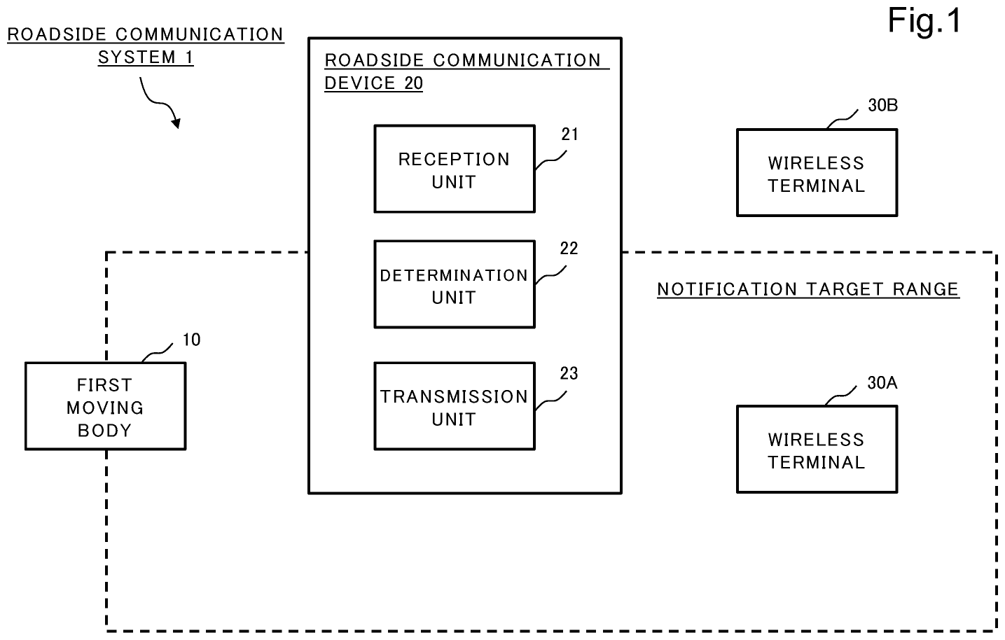

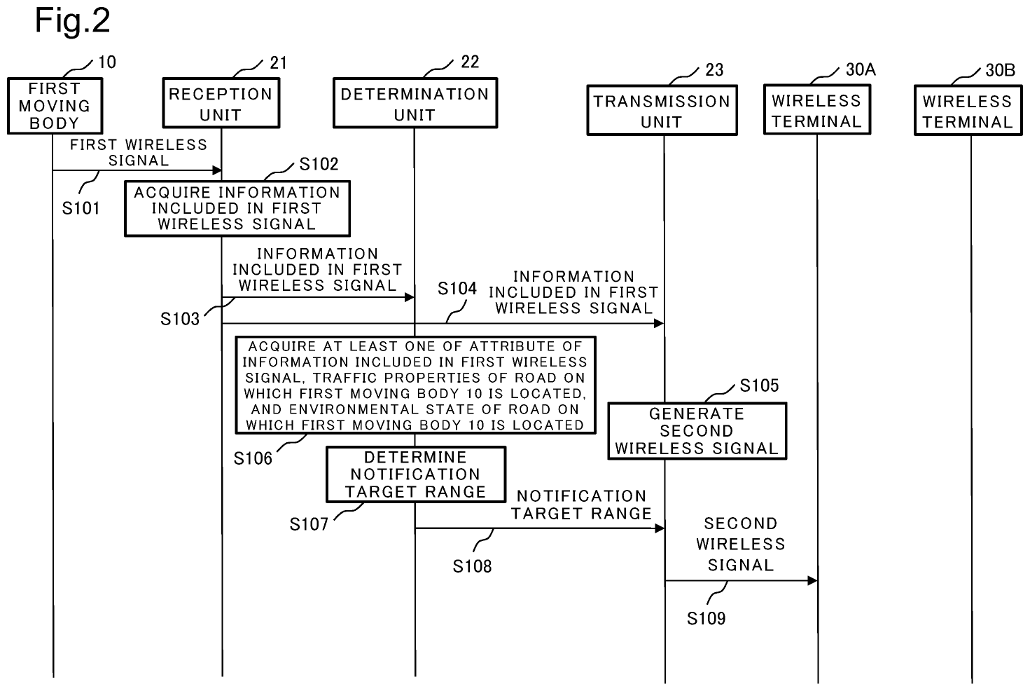

A roadside communication system 1 according to a first example embodiment is described with reference to FIG. 1 and FIG. 2. FIG. 1 is a block diagram illustrating a configuration example of the roadside communication system 1. Further, FIG. 2 is a sequence diagram illustrating an operation example of the roadside communication system 1.

As illustrated in FIG. 1, the roadside communication system 1 includes a first moving body 10, a roadside communication device 20, and wireless terminals 30A and 30B. A notification target range illustrated in FIG. 1 is a range determined by a determination unit 22, which is described later. When there is no need to distinguish the wireless terminals 30A and 30B from each other, each of the wireless terminals 30A and 30B is referred to as the wireless terminal 30.

In the roadside communication system 1, the first moving body 10 may transmit, to the wireless terminal 30 located nearby, a first wireless signal including location information relating to the first moving body 10, a moving speed, a traveling state, information relating to an occupant, and the like. The roadside communication device 20 transfers those pieces of information to another wireless terminal 30. With this, for example, when the wireless terminal 30 is an on-vehicle device mounted on a vehicle, the wireless terminal 30 may perform automatic driving of the vehicle or driving support for an occupant of the vehicle by using the transferred information. In this manner, the information from the first moving body 10 enables the vehicle on which the wireless terminal 30 is mounted to perform safe driving.

The first moving body 10 transmits the first wireless signal to the roadside communication device 20. For example, the first moving body is a vehicle, an on-vehicle device included in a vehicle, or a communication terminal owned by an occupant of a vehicle. Further, the first moving body 10 may be a communication terminal owned by a pedestrian.

The first wireless signal includes various types of information relating to the first moving body. For example, when the first moving body includes a positioning means such as Global Navigation Satellite System (GNSS) and Global Positioning System (GPS) with which its own location information can be acquired, the first wireless signal may include information indicating a location of the first moving body 10. Further, when the first moving body 10 is a vehicle or an on-vehicle device, the first moving body 10 may acquire an own speed from a speed indicator provided to the vehicle, and the first wireless signal may include information indicating the own speed, for example. The information described above is merely an example, and the first wireless signal may include other pieces of information.

The roadside communication device 20 includes a reception unit 21, the determination unit 22, and a transmission unit 23. For example, the roadside communication device 20 is installed on a road on which a vehicle travels or a sidewalk. The reception unit 21, the determination unit 22, and the transmission unit 23 are not required to be provided to one roadside communication device 20, and each of them may be provided to difference devices and operate as one system. Further, a program that causes an information processing device such as a computer to achieve each of the reception unit 21, the determination unit 22, and the transmission unit 23 may be stored in a recording medium such as a hard disk drive. The reception unit 21, the determination unit 22, and the transmission unit 23 are associated with a reception means, a determination means, and a transmission means, respectively.

The reception unit 21 receives the first wireless signal from the first moving body 10. The reception unit 21 acquires the information included in the first wireless signal, and outputs the information to the determination unit 22 and the transmission unit 23.

The determination unit 22 determines the notification target range, based on at least one of an attribute of the information included in the first wireless signal, traffic properties of a road on which the first moving body is located, and an environmental state of the road. Further, the determination unit 22 may notify the transmission unit 23 of the determined notification target range.

For example, when the information acquired from the reception unit 21 includes at least one of an importance degree and an urgency degree of the information, the determination unit 22 determines the notification target range to be wider as the importance degree and the urgency degree are higher. Meanwhile, as the importance degree and the urgency degree are lower, the determination unit 22 may determine the notification target range to be narrower. With this, the roadside communication device 20 is capable of transferring the information to a larger number of wireless terminals as the importance degree of the information is higher.

Further, for example, when the information acquired from the reception unit 21 indicates a notification destination of the information, the determination unit 22 determines the notification target range according to the notification destination. For example, the notification destination of the information indicates types of the wireless terminal 30, such as an on-vehicle device and a smartphone. For example, when the notification destination of the information is an on-vehicle device mounted on a vehicle, the determination unit 22 sets the notification target range to be wider. Meanwhile, when the notification destination of the information is a wireless communication terminal such as a smartphone or a mobile phone owned by a user, the determination unit 22 sets the notification target range to be narrower. With this, the roadside communication device 20 is capable of transferring the information to the number of wireless terminals according to the notification destination indicated by the information.

Further, for example, it is assumed that the traffic properties of the road indicate a regulation speed of the road or the statistic value of the speed of the vehicle traveling on the road. In this case, when the information acquired from the reception unit 21 includes the location information relating to the first moving body 10, the determination unit 22 specifies a road on which the first moving body 10 is located, and determines the notification target range according to the regulation speed of the road or the statistic value of the speed of the vehicle traveling on the road. For example, the determination unit 22 stores a correlation between roads and location information, and specifies the road associated with the location information relating to the first moving body 10 that is included in the information acquired from the reception unit 21. In the correlation, location information may be associated with each of route names or route numbers of roads. Further, the determination unit 22 stores the regulation speed or the statistic value of the speed of the vehicle for each road, and acquires the regulation speed or the statistic value of the speed of the specified road. For example, the statistic value of the speed is an average value of a speed that is measured during a predetermined period by a device, which is omitted in illustration, capable of measuring a speed of a vehicle traveling on a road. The determination unit 22 sets the notification target range to be wider as the acquired regulation speed is higher or the acquired statistic value of the speed is greater. Meanwhile, the determination unit 22 sets the notification target range to be narrower as the acquired regulation speed is lower or the acquired statistic value of the speed is less. The determination unit 22 is not required to store the correlation between the roads and the location information, the regulation speed of each road, and the statistic value of the speed of the vehicle for each road, and may acquire those pieces of information from an external server.

In a case in which the first moving body 10 and the wireless terminal being a transfer destination of the information travel on the same road, when the moving speed of the first moving body 10 is high, the wireless terminal being a transfer destination also tends to travel at a high speed. It is preferred that the wireless terminal traveling at a high speed acquires the information in an early stage in such a way that the information can be processed with sufficient time. In view of this, the determination unit 22 sets the notification target range to be wider as the acquired regulation speed is higher or the acquired statistic value of the speed is greater. With this, the roadside communication device 20 is capable of transferring the information to the wireless terminal 30 that is estimated to travel at a high speed, at an early timing. Therefore, for example, when the wireless terminal 30 is an on-vehicle device that performs automatic driving, the on-vehicle device is capable of processing the information from the first moving body 10 with sufficient time, and hence automatic driving can be performed safely.

Further, for example, the determination unit 22 may determine the notification target range, based on the environmental state of the road. The environmental state indicates weather or an illuminance of the road on which the first moving body 10 is located. For example, the determination unit 22 acquires, from the reception unit 21, the location information relating to the first moving body 10. The determination unit 22 accesses a server of the meteorological agency or the like, and grasps the weather at the location indicated by the acquired location information. When the weather is rainy, the determination unit 22 determines the notification target range to be wider. Further, when the weather is sunny, the determination unit 22 determines the notification target range to be narrower. Further, the information acquired from the reception unit 21 includes the illuminance for the first moving body 10, the determination unit 22 determines the notification target range to be wider as the illuminance is lower. The determination unit 22 may determine the notification target range, based on the illuminance acquired from the roadside communication device 20 or an illuminance sensor, which is omitted in illustration, provided to the road.

For example, when an occupant of a vehicle is notified of the information from the first moving body 10 by the wireless terminal 30 being a transfer destination, the occupant or the on-vehicle device that grasps the information drives the vehicle according to the information and circumstances. In this state, when the surrounding illuminance is lower due to a night time or rain, the determination unit 22 is capable of setting the notification target range to be wider, based on the weather and the illuminance and transferring the information to the wireless terminal 30 at an early timing. With this, the occupant or the on-vehicle device can grasp the information at an early timing, and thus can perform an appropriate operation. Alternatively, when the surrounding illuminance is high due to a day time, sunny weather, or the like, an appropriate operation can be performed without grasping the information at an early timing, and hence the notification target range is set to be narrower as compared to a case in which the surrounding illuminance is lower due to a night time or rain. With this, power required for transmitting a second wireless signal, which is described later, can be suppressed.

The transmission unit 23 transmits the second wireless signal including the information from the first moving body 10 to the wireless terminal within the notification target range.

The transmission unit 23 generates the second wireless signal, based on the information included in the first wireless signal that is acquired from the reception unit 21. For example, the second wireless signal may include the location information relating to the first moving body 10, the speed, and the like.

The transmission unit 23 transmits the second wireless signal, based on the notification target range notified from the determination unit 22. For example, when the notification target range is wide, the transmission unit 23 transmits the second wireless signal at high intensity. With this, the second wireless signal is received by the wireless terminal located within a wider range. Further, for example, as illustrated in FIG. 1, the second wireless signal is received by the wireless terminal 30A located within the notification target range, but is not received by the wireless terminal 30B located outside the notification target range. The wireless terminal 30 is a vehicle, an on-vehicle device included in a vehicle, or a communication terminal owned by an occupant of a vehicle. Further, the wireless terminal 30 may be a communication terminal owned by a pedestrian. For example, when a new communication target range is notified from the determination unit 22, the transmission unit 23 changes a transmission range of the second wireless signal by changing intensity of the second wireless signal.

Next, with reference to FIG. 2, the operation of the roadside communication system 1 is described. FIG. 2 is a sequence diagram illustrating the operation of the roadside communication system 1.

The first moving body 10 transmits the first wireless signal (S101). The reception unit 21 acquires the information included in the first wireless signal (S102). The reception unit 21 outputs the acquired information to the determination unit 22 (S103). Further, the reception unit 21 outputs the acquired information to the transmission unit 23 (S104). The transmission unit 23 generates the second wireless signal including the acquired information (S105).

The determination unit 22 acquires, from the information output from the reception unit 21, at least one of the attribute of the information included in the first wireless signal, the traffic properties of the road on which the first moving body 10 is located, and the environmental state of the road on which the first moving body 10 is located (S106). Further, the determination unit 22 determines the notification target range (S107). A specific example of determination of the notification target range is as described for the above-mentioned determination unit 22. The determination unit 22 outputs the notification target range to the transmission unit 23 (S108). The transmission unit 23 outputs the second wireless signal at intensity according to the notification target range being notified (S109). In this state, for example, as illustrated in FIG. 1, the second wireless signal is received by the wireless terminal 30A located within the notification target range, but is not received by the wireless terminal 30B located outside the notification target range.

As described above, according to the roadside communication device 20, the notification target range is determined based on at least one of the attribute of the information included in the first wireless signal, the traffic properties of the road on which the first moving body 10 is located, and the environmental state of the road on which the first moving body 10 is located. Thus, the roadside communication device 20 is capable of transferring the information from the first moving body 10 to an appropriate vehicle according to at least one of the attribute of the information included in the first wireless signal, the traffic properties of the road on which the first moving body 10 is located, and the environmental state of the road on which the first moving body 10 is located.

### Second Example Embodiment

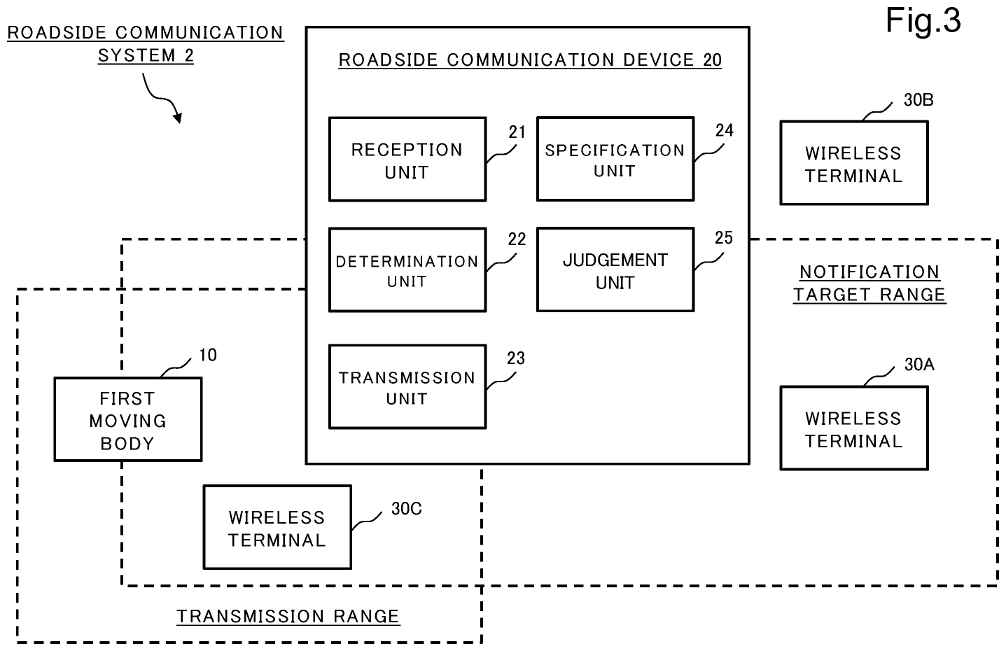

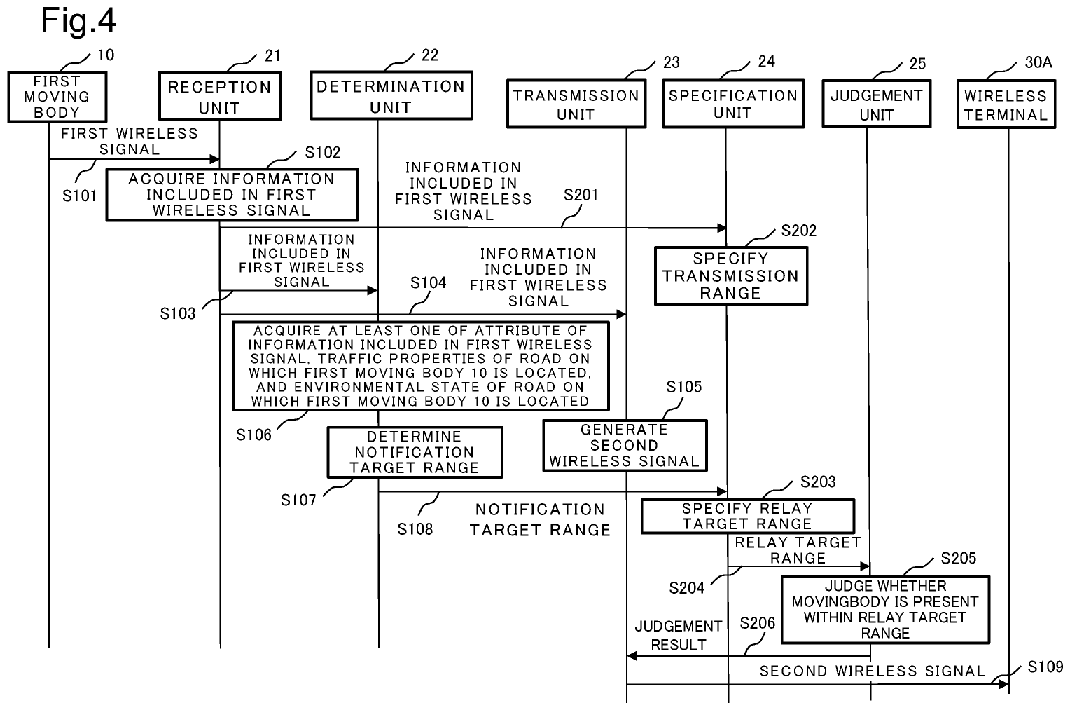

A roadside communication system 2 according to a second example embodiment is described with reference to FIG. 3 and FIG. 4. FIG. 3 is a block diagram illustrating a configuration example of the roadside communication system 2. Further, FIG. 4 is a sequence diagram illustrating an operation example of the roadside communication system 2. The roadside communication system 2 includes the first moving body 10, the roadside communication device 20, and wireless terminals 30A, 30B, and 30C. A transmission range illustrated in FIG. 2 is a range determined by a specification unit 24, which is described later. When there is no need to distinguish the wireless terminals 30A, 30B, and 30C from one another, each of the wireless terminals 30A, 30B, and 30C is referred to as the wireless terminal 30.

The roadside communication device 20 of the roadside communication system 2 is different from the roadside communication device 20 of the roadside communication system 1 in that the specification unit 24 and a determination unit 25 are further included. The reception unit 21, the determination unit 22, the transmission unit 23, the specification unit 24, and the determination unit 25 are not required to be provided to one roadside communication device 20, and each of them may be provided to difference devices and operate as one system. Further, a program that causes an information processing device such as a computer to achieve each of the reception unit 21, the determination unit 22, the transmission unit 23, the specification unit 24, and the determination unit 25 may be stored in a recording medium such as a hard disk drive. The specification unit 24 and the determination unit 25 are associated with a specification means and a determination means, respectively.

The specification unit 24 specifies the transmission range within which the first moving body 10 is capable of transmitting the first wireless signal. For example, the reception unit 21 further outputs, to the specification unit 24, the information included in the first wireless signal, and the specification unit 24 specifies the transmission range, based on the information. For example, the specification unit 24 stores a correlation between a type of a terminal and a transmission range in advance, and specifies the transmission range associated with the type of the terminal when the acquired information includes the type of the terminal.

The specification unit 24 may acquire the correlation from an external server. Further, when the information acquired from the reception unit 21 indicates the transmission range, the specification unit 24 may specify the transmission range directly from the acquired information instead of specifying the transmission range from the correlation. Further, the specification unit 24 may specify a predetermined range as the transmission range without referring to the information acquired from the reception unit 21.

Further, when the received information includes the location of the first moving body 10, the specification unit 24 may specify the transmission range, based on the location of the first moving body 10 and propagation properties of the first wireless signal. For example, the propagation properties of the first wireless signal indicate a distance by which the first wireless signal propagates at intensity receivable by a communication device. For example, the propagation properties of the first wireless signal are specified from the type of the first moving body 10. In this case, the specification unit 24 specifies, as the transmission range, a range including the location of the first moving body 10 as its center and having, as its radius, the distance by which the first wireless signal propagates at intensity receivable by a communication device.

Moreover, the specification unit 24 specifies a relay target range other than the transmission range in the notification target range determined by the determination unit 22. Specifically, for example, the specification unit 24 acquires the location information within the notification target range from the determination unit 22, and specifies, as the relay target range, a range associated with the location information that is within the notification target range and outside of the transmission range. In the example of FIG. 3, the wireless terminal 30A is within the relay target range, but the wireless terminal 30B and the wireless terminal 30C are not within the relay target range. The specification unit 24 outputs the specified relay target range to the determination unit 25.

The determination unit 25 determines whether another moving body (a second moving body) is present within the relay target range. For example, the determination unit 25 determines whether the second moving body is present within the relay target range, based on a monitoring result of a monitoring means that is provided communicably with the roadside communication device 20. For example, when the monitoring means is a camera, the camera captures an image of an actual space associated with the inside of the relay target range, and when the captured image or video includes a vehicle or the like, the determination unit 25 determines that the another moving body (the second moving body) is present within the relay target range. The determination unit 25 outputs, to the transmission unit 23, a determination result indicating whether the another moving body is present within the relay target range. When it is determined that the another moving body is present within the relay target range, the determination unit 25 further transmits the location information within the relay target range to the transmission unit 23.

When the determination result from the determination unit 25 indicates that the another moving body is not present within the relay target range, the transmission unit 23 does not transmit the second wireless signal. Meanwhile, when the determination result from the determination unit 25 indicates that the another moving body is present within the relay target range, the transmission unit 23 transmits the second wireless signal. In this case, for example, the transmission unit 23 transmits the second wireless signal to the wireless terminal 30 within the relay target range by transmitting the second wireless signal at intensity associated with an area of the relay target range. In this state, the transmission unit 23 may provide the second wireless signal with directivity associated with a shape of the relay target range by executing known beam forming control.

An operation of the roadside communication system 2 is described with reference to FIG. 4. The processing from S101 to S109 illustrated in FIG. 4 is similar to the processing from S101 to S109 of the roadside communication system 1 illustrated in FIG. 2, and hence description thereof is omitted. In the processing in S108 of the operation of the roadside communication system 2, the determination unit 22 outputs the notification target range to the specification unit 24.

In the roadside communication system 2, the reception unit 21 outputs, to the specification unit 24, the information included in the first wireless signal. The specification unit 24 specifies the transmission range of the first wireless signal, based on the information acquired from the reception unit 21 (S202). The specification unit 24 further specifies the relay target range that is within the notification target range output from the determination unit 22 and is outside of the transmission range (S203). The specification unit 24 outputs the relay target range to the determination unit 25 (S204). The determination unit 25 determines whether a moving body is present within the relay target range (S205). The determination unit 25 outputs, to the transmission unit 23, the determination result indicating whether a moving body is present within the relay target range (S206). When the determination result from the determination unit 25 indicates that the another moving body is not present within the relay target range, the transmission unit 23 does not transmit the second wireless signal. Meanwhile, when the determination result from the determination unit 25 indicates that the another moving body is present within the relay target range, the transmission unit 23 transmits the second wireless signal similarly to the processing in S109.

As described above, in the roadside communication system 2, when the determination result from the determination unit 25 indicates the another moving body is not present within the relay target range, the transmission unit 23 does not transmit the second wireless signal. With this, the transmission unit 23 does not transmit the second wireless signal to the wireless terminal 30 within the transmission range to which the first moving body 10 is capable of directly transmitting the first wireless signal. Thus, according to the roadside communication system 2, the processing executed by the transmission unit 23 can be simplified.

Further, similarly to the roadside communication device 20 of the roadside communication system 1, the roadside communication device 20 of the roadside communication system 2 includes the reception unit 21, the determination unit 22, and the transmission unit 23, and hence is capable of transferring the information from the first moving body 10 to an appropriate vehicle according to at least one of the attribute of the information included in the first wireless signal, the traffic properties of the road on which the first moving body 10 is located, and the environmental state of the road on which the first moving body 10 is located.

### Third Example Embodiment

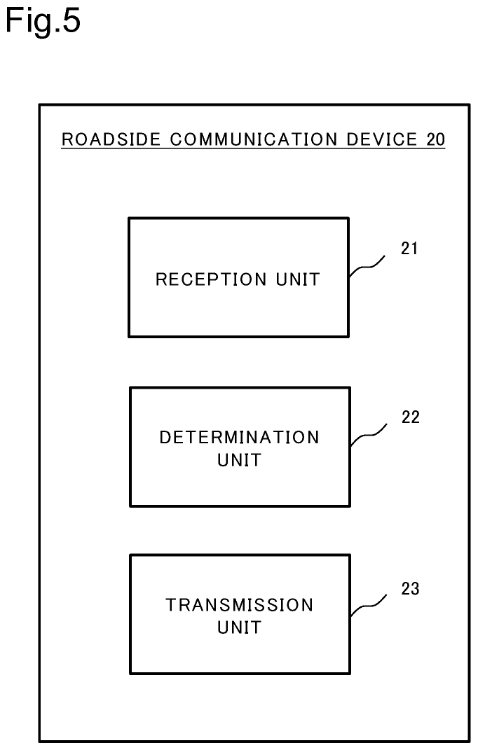

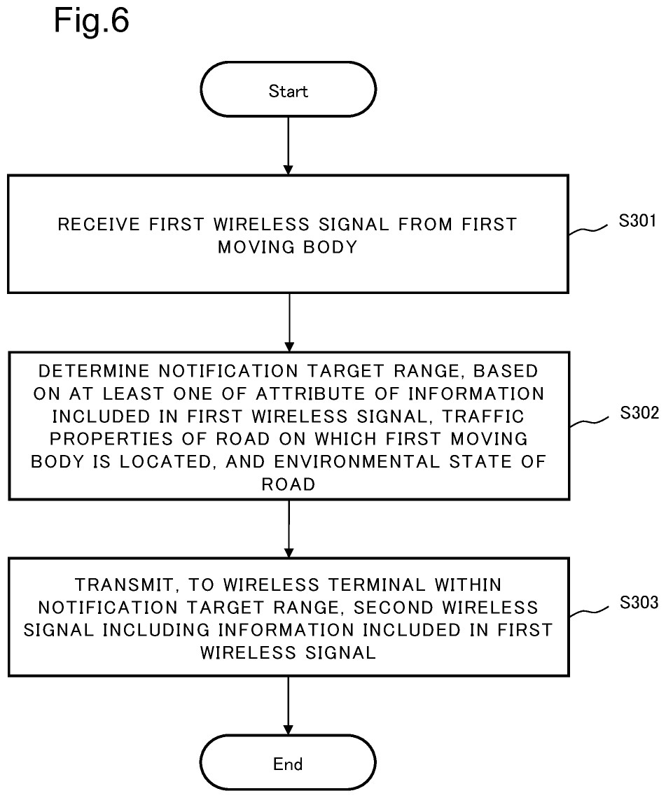

The roadside communication device 20 according to a third example embodiment is described with reference to FIG. 5 and FIG. 6. As illustrated in FIG. 5, the roadside communication device 20 includes the reception unit 21, the determination unit 22, and the transmission unit 23. FIG. 6 is a flowchart illustrating an operation of the roadside communication device 20. The reception unit 21, the determination unit 22, and the transmission unit 23 are not required to be provided to one device, and may be provided to different devices and operate as one system. Further, a program that causes an information processing device such as a computer to achieve each of the reception unit 21, the determination unit 22, and the transmission unit 23 may be stored in a recording medium such as a hard disk drive.

The reception unit 21 receives the first wireless signal from the first moving body. The reception unit 21 may have a function and a connection relationship that are similar to those of the reception unit 21 in the roadside communication systems 1 and 2 described above.

The determination unit 22 determines the notification target range, based on at least one of the attribute of the information included in the first wireless signal, the traffic properties of the road on which the first moving body is located, and the environmental state of the road. The determination unit 22 may have a function and a connection relationship that are similar to those of the determination unit 22 in the roadside communication systems 1 and 2 described above.

The transmission unit 23 transmits the second wireless signal including the information included in the first wireless signal, to the wireless terminal within the notification target range determined by the determination unit 22. The transmission unit 23 may have a function and a connection relationship that are similar to those of the transmission unit 23 in the roadside communication systems 1 and 2 described above.

Next, the operation of the roadside communication device 20 is described with reference to FIG. 6.

The reception unit 21 receives the first wireless signal from the first moving body (S301). The determination unit 22 determines the notification target range, based on at least one of the attribute of the information included in the first wireless signal, the traffic properties of the road on which the first moving body is located, and the environmental state of the road (S302). The transmission unit 23 transmits the second wireless signal including the information included in the first wireless signal, to the wireless terminal within the notification target range (S303).

As described above, according to the roadside communication device 20, the notification target range is determined based on at least one of the attribute of the information included in the first wireless signal, the traffic properties of the road on which the first moving body is located, and the environmental state of the road on which the first moving body is located. Thus, the roadside communication device 20 is capable of transferring the information from the first moving body to an appropriate vehicle, according to at least one of the attribute of the information included in the first wireless signal, the traffic properties of the road on which the first moving body is located, and the environmental state of the road on which the first moving body 10 is located.

The whole or a part of the example embodiments described above can be described as, but not limited to, the following supplementary notes.

### (Supplementary Note 1)

A roadside communication device including:
a reception means for receiving a first wireless signal from a first moving body;
a determination means for determining a notification target range, based on at least one of an attribute of information included in the first wireless signal, traffic properties of a road on which the first moving body is located, and an environmental state of the road; and
a transmission means for transmitting a second wireless signal including the information, to a wireless terminal within the notification target range.

### (Supplementary Note 2)

The roadside communication device according to Supplementary Note 1, wherein the determination means changes the notification target range, based on at least one of the attribute of the information, the traffic properties, and the environmental state.

### (Supplementary Note 3)

The roadside communication device according to Supplementary Note 2, wherein
the attribute is an importance degree or an urgency degree of the information, and
the determination means changes the notification target range according to the importance degree or the urgency degree.

### (Supplementary Note 4)

The roadside communication device according to Supplementary Note 2 or 3, wherein
the attribute is a notification destination of the information, and
the determination means changes the notification target range according to the notification destination.

### (Supplementary Note 5)

The roadside communication device according to any one of Supplementary Notes 2 to 4, wherein
the traffic properties are a regulation speed of the road or a statistic value of a speed of a vehicle traveling on the road, and
the determination means changes the notification target range according to the regulation speed or the statistic value.

### (Supplementary Note 6)

The roadside communication device according to any one of Supplementary Notes 2 to 5, wherein
the environmental state is weather or an illuminance of the road, and
the determination means changes the notification target range according to the weather or the illuminance.

### (Supplementary Note 7)

The roadside communication device according to any one of Supplementary Notes 1 to 6 further including:
a specification means for specifying a relay target range other than a transmission range in which the first moving body is capable of transmitting the first wireless signal within the notification target range; and
a determination means for determining whether a second moving body is present, within the relay target range, wherein,
when the second moving body is not present within the relay target range, the transmission means does not transmit the second wireless signal.

### (Supplementary Note 8)

The roadside communication device according to Supplementary Note 7, wherein the specification means specifies the transmission range, based on a location of the first moving body and propagation properties of the first wireless signal.

### (Supplementary Note 9)

The roadside communication device according to Supplementary Note 7 or 8 further including:
a monitoring means for monitoring the relay target range, wherein
the determination means determines whether the second moving body is present within the relay target range, based on a monitoring result of the monitoring means.

### (Supplementary Note 10)

The roadside communication device according to any one of Supplementary Notes 7 to 9, wherein
the transmission means changes a transmission range of the second wireless signal according to the relay target range.

### (Supplementary Note 11)

The roadside communication device according to any one of Supplementary Notes 1 to 10, wherein
the transmission means changes a transmission range of the second wireless signal according to the notification target range.

### (Supplementary Note 12)

A roadside communication method including:
receiving a first wireless signal from a first moving body;
determining a notification target range, based on at least one of an attribute of information included in the first wireless signal, traffic properties of a road on which the first moving body is located, and an environmental state of the road; and
transmitting a second wireless signal including the information, to a wireless terminal within the notification target range.

### (Supplementary Note 13)

A recording medium recording a program causing an information processing device to execute:
processing of receiving a first wireless signal from a first moving body;
processing of determining a notification target range, based on at least one of an attribute of information included in the first wireless signal, traffic properties of a road on which the first moving body is located, and an environmental state of the road; and
processing of transmitting a second wireless signal including the information, to a wireless terminal within the notification target range.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2 Roadside communication system
10 First moving body
20 Roadside communication device
21 Reception unit
22 Determination unit
23 Transmission unit
24 Specification unit
25 Determination unit
30, 30A, 30B, 30C Wireless terminal

What is claimed is:

1. A roadside communication device comprising:
reception unit configured to receive a first wireless signal from a first moving body;
at least one memory configured to store instructions; and at least one processor configured to execute the instructions to determine a notification target range, based on at least one of an attribute of information included in the first wireless signal, traffic properties of a road on which the first moving body is located, and an environmental state of the road; and
transmission unit configured to transmit a second wireless signal including the information, to a wireless terminal within the notification target range.

2. The roadside communication device according to claim 1, wherein the at least one processor changes the notification target range, based on at least one of the attribute of the information, the traffic properties, and the environmental state.

3. The roadside communication device according to claim 2, wherein
the attribute is an importance degree or an urgency degree of the information, and
the at least one processor changes the notification target range according to the importance degree or the urgency degree.

4. The roadside communication device according to claim 2, wherein
the attribute is a notification destination of the information, and
the at least one processor changes the notification target range according to the notification destination.

5. The roadside communication device according to claim 2, wherein
the traffic properties are a regulation speed of the road or a statistic value of a speed of a vehicle traveling on the road, and
the at least one processor changes the notification target range according to the regulation speed or the statistic value.

6. The roadside communication device according to claim 2, wherein
the environmental state is weather or an illuminance of the road, and
the at least one processor changes the notification target range according to the weather or the illuminance.

7. The roadside communication device according to claim 1, wherein
the at least one processor specifies a relay target range other than a transmission range in which the first moving body is capable of transmitting the first wireless signal, within the notification target range; and
the at least one processor determines whether a second moving body is present within the relay target range, wherein,
when the second moving body is not present within the relay target range, the transmission unit does not transmit the second wireless signal.

8. The roadside communication device according to claim 7, wherein the at least one processor specifies the transmission range, based on a location of the first moving body and propagation properties of the first wireless signal.

9. The roadside communication device according to claim 7 or 8 further comprising:
monitoring unit configured to monitor the relay target range, wherein
the at least one processor determines whether the second moving body is present within the relay target range, based on a monitoring result of the monitoring means.

10. The roadside communication device according to claim 7, wherein
the transmission unit changes a transmission range of the second wireless signal according to the relay target range.

11. The roadside communication device according to claim 1, wherein
the transmission unit changes a transmission range of the second wireless signal according to the notification target range.

12. A roadside communication method comprising:
receiving a first wireless signal from a first moving body;
determining a notification target range, based on at least one of an attribute of information included in the first wireless signal, traffic properties of a road on which the first moving body is located, and an environmental state of the road; and
transmitting a second wireless signal including the information, to a wireless terminal within the notification target range.

13. A non-transitory computer readable recording medium recording a program causing an information processing device to execute:
processing of receiving a first wireless signal from a first moving body;
processing of determining a notification target range, based on at least one of an attribute of information included in the first wireless signal, traffic properties of a road on which the first moving body is located, and an environmental state of the road; and
processing of transmitting a second wireless signal including the information, to a wireless terminal within the notification target range.

14. The roadside communication device according to claim 3, wherein
the attribute is a notification destination of the information, and
the at least one processor changes the notification target range according to the notification destination.

15. The roadside communication device according to claim 3, wherein
the traffic properties are a regulation speed of the road or a statistic value of a speed of a vehicle traveling on the road, and
the at least one processor changes the notification target range according to the regulation speed or the statistic value.

16. The roadside communication device according to claim 3, wherein
the traffic properties are a regulation speed of the road or a statistic value of a speed of a vehicle traveling on the road, and
the at least one processor changes the notification target range according to the regulation speed or the statistic value.

17. The roadside communication device according to claim 14, wherein
the traffic properties are a regulation speed of the road or a statistic value of a speed of a vehicle traveling on the road, and
the at least one processor changes the notification target range according to the regulation speed or the statistic value.

18. The roadside communication device according to claim 3, wherein
the environmental state is weather or an illuminance of the road, and
the at least one processor changes the notification target range according to the weather or the illuminance.

19. The roadside communication device according to claim 4, wherein
the environmental state is weather or an illuminance of the road, and
the at least one processor changes the notification target range according to the weather or the illuminance.

20. The roadside communication device according to claim 5, wherein
the environmental state is weather or an illuminance of the road, and
the at least one processor changes the notification target range according to the weather or the illuminance.
